(19) United States
(12) Patent Application Publication
(10) Pub. No.: US 2020/0323387 A1
(43) Pub. Date: Oct. 15, 2020

(54) Foaming and Heating Device and System Integrating Such a Device

(71) Applicant: NESTEC S.A., Vevey (CH)

(72) Inventor: Grégory SAVIOZ, Saxonne (CH)

(73) Assignee: Nestec S.A., Vevey (CH)

(21) Appl. No.: 16/304,876

(22) PCT Filed: Jun. 8, 2017
(86) PCT No.: PCT/EP2017/063896

§ 371 Date: Nov. 27, 2018

(30) Foreign Application Priority Data
Jun. 15, 2016 (EP) 16174649.0

(51) Int. Cl. A47J 31/54; A47J 31/44; A47J 31/60

(52) U.S. Cl. CPC A47J 31/542; B01F 2215/0006; A47J 31/60; A47J 31/4485

(57) ABSTRACT

The invention refers to a foaming and heating device (10) for foaming and/or heating a fluid or a fluid foam on demand comprising a fluid container (11) where a foamable fluid is stored; a pumping unit (120) and a foaming unit (121), both entrained in rotation by a single shaft, such that this same rotation provides pumping of the fluid from the container (11) and foaming of it when air is introduced through an air inlet (18); the device (10) further comprising a heating unit (13), the heating unit (13) comprising a path (131) through which the foamed fluid flows and a heating element (132) arranged facing this path (131) so that the fluid can be heated; the heating element (132) being electrically heated.

Further, the invention refers to a foaming and heating system (100) comprising such a device (10) and a machine (20) to which the device (10) is connected, the machine (20) comprising single driving means (22) entraining in rotation both the pumping unit (120) and the foaming unit (121); the machine (20) further comprising an electrical connection (23) to heat the heating unit (13).

### CROSS-REFERENCE TO RELATED APPLICATIONS/INCORPORATION BY REFERENCE STATEMENT

This application is a US national stage application filed under 35 USC § 371 of International Application No. PCT/EP2017/063896, filed Jun. 8, 2017; which claims priority to EP App No. 16174649.0, filed Jun. 15, 2016. The entire contents of the above-referenced patent applications are hereby expressly incorporated herein by reference.

### TECHNICAL FIELD

The present disclosure is directed to a foaming and heating device for preparing hot fluid foams on demand. The present disclosure further relates to a system integrating such a device.

### BACKGROUND

Fluid foams consist of two phases, an aqueous phase and a gaseous (air) phase. A fluid foam is a substance which is formed by trapping many gas bubbles in a fluid structure: producing a fluid foam involves not only the generation of these gas bubbles, but also the packing and the retention of these bubbles into the overall fluid structure in order to provide a stable foam.

Nowadays, there exists the trend of consuming a wider variety of coffee types, most of them containing considerably more milk than before. These new coffee types comprise very often milk foams, so providing a good quality foam which is stable for a long time is a present need. As a consequence, there is a strong need for a foam heating technology, particularly for a milk foam heating technology for a wide range of businesses, particularly involving beverage preparations. As for now, no practical cleaning solution exists and the consumer always has to clean parts of the machine through which milk circulated: this becomes a hassle when milk is involved because milk deteriorates rapidly with time and the system needs to be thoroughly cleaned very often, preferably after each use. Superior quality milk foam is also more and more required and the heating system has to be smartly designed so as not to decrease the foam quality and provide a superior in cup result, providing at the same time practical and easy cleaning ways.

At present, there exist current systems which are able to provide superior quality milk foam: this milk foam is generated from cold milk and is then heated up at a later stage so that the creamy texture is kept stable for a longer period of time: this entrains the difficulty of being able to heat up the foam without degrading its texture.

There are different ways of heating up cold milk foam known in the state of the art. Some use a heat transfer device, such as for example a thermobloc, which heats the milk foam once it has been produced. The problem of using such heat transfer devices is that they need to be deeply cleaned every day as milk fluid circulates within the heat transfer device, can deteriorate and be a source of contamination when staying longer in the device. Moreover, these systems are cleaned preferably by being rinsed using several times the amount of water they would require for a normal operation or dosing. Some other known systems use a direct flow of steam through the milk foam already formed in order to heat it up: however, this destroys the texture of the milk foam thus providing very low quality foam in cup.

It is known in the state of the art, for example as per WO 2014/077692, a disposable heat exchanger comprising a flexible coil with a product inlet and a product outlet for a perishable product, such as a milk product: a heating medium is also provided surrounding the flexible coil in order to heat the perishable product which circulates through it. This document further discloses a frothing module, preferably disposed before the product outlet in the heat exchanger for frothing the heated milk product. However, this system has the problem that the frothing is done after the milk has been heated, which therefore provides low quality milk foam. Moreover, the arrangement of the heat exchanger disclosed in this document is not compact and works with higher quantities of fluid (typically comprised between 5 and 10 liters of fluid) which makes that part of the fluid remains inside the system and can therefore be contaminated.

It is therefore one non-limiting object of the present disclosure to provide a gentle, non-destructive and powerful heating system for superior quality milk foam on demand, which is easy to operate and to clean and maintain by a user.

### BRIEF DESCRIPTION OF THE DRAWINGS

Further features, advantages and objects of the present disclosure will become apparent for a skilled person when reading the following detailed description of non-limiting embodiments of the present disclosure, when taken in conjunction with the appended drawings, in which:

FIG. 1 shows a general overview of a foaming and heating device according to a first embodiment of the present disclosure.

FIG. 2 shows a detailed view of the pumping and foaming unit and of the heating unit in the foaming and heating device in FIG. 1.

FIGS. 3 and 4 show a general overview of a beverage system integrating a heating and foaming device according to a first embodiment of the present disclosure, as shown in FIGS. 1 and 2.

FIGS. 5a-b show a general overview of a foaming and heating device according to a second embodiment of the present disclosure.

FIGS. 6a-b show a detailed view of the pumping and foaming unit and of the heating unit in the foaming and heating device in FIGS. 5a-b.

FIGS. 7a-b show further views of the pumping and foaming unit and of the heating unit in the foaming and heating device in FIGS. 5a-b.

FIG. 8 shows the different main components in a foaming and heating device as shown in FIGS. 5a-b.

FIG. 9 shows a general overview of a foaming and heating device according to a third embodiment of the present disclosure.

FIG. 10 shows a further detail of the foaming and heating device according to a third embodiment of the disclosure, as shown in FIG. 9.

FIG. 11 shows a general overview of a fluid container used in a device as shown in FIG. 9 or 10.

FIG. 12 shows a general overview of a beverage system where a heating and foaming device according to a third embodiment of the present disclosure, as shown in FIGS. 9 and 10, will be integrated.

FIG. 13 shows the beverage system of FIG. 12 where the heating and foaming device according to a third embodiment of the present disclosure, as shown in FIGS. 9 and 10, has been integrated.

### DETAILED DESCRIPTION

According to a first aspect, the present disclosure refers to a foaming and heating device for foaming and/or heating a fluid or a fluid foam on demand comprising a fluid container where a foamable fluid is stored; a pumping unit and a foaming unit, both entrained in rotation by a single shaft, such that this same rotation provides pumping of the fluid from the container and foaming of it when air is introduced through an air inlet; the device further comprising a heating unit. The heating unit comprises a path through which the foamed fluid flows and a heating element arranged facing this path so that the fluid can be heated; the heating element being electrically heated.

In certain non-limiting embodiments, the path is configured having a labyrinth shape, the heating element being configured as an electrically heated surface covering the planar surface of the path. The path can be configured as a conical spiral, the heating element being configured as an outer conical sleeve matching the spiral, electrically heated.

According to an embodiment, the pumping unit is configured as gears.

According to a different embodiment, the foaming unit is configured as a disc, as a cone or as a cylinder.

Typically, in the foaming and heating device of the present disclosure, the foaming unit comprises a rotatable element with respect to a static element defining a gap where a mixture of fluid and air is driven under shear stress to be foamed. The gap is typically comprised between 0.2 and 1 mm, such as (but not limited to) between 0.3 and 0.6 mm.

According to a possible embodiment, the pumping unit is the same as the foaming unit, both being configured as a single rotatable disc.

In certain non-limiting embodiments, according to the present disclosure, the module and/or number and/or height of the teeth configuring the gears in the pumping unit, and the shape and/or size of the foaming unit are calculated so as to have a specific balance between the pumping performance and the foaming capability, respectively, provided by the device.

Typically, the device further comprises a temperature sensor to measure the heating unit temperature.

In certain non-limiting embodiments, the pumping unit and the foaming unit rotate around the shaft at a speed comprised between 2000 and 10000 rpm, such as (but not limited to) between 4000 and 8000 rpm.

Also in certain non-limiting embodiments, the pumping unit, the foaming unit and the heating unit are made detachable and accessible for being cleaned.

According to another embodiment of the present disclosure, the foaming and heating device can further comprise a secondary air entry for injecting air into the container in order to replace the fluid removed from it.

According to a second aspect, the present disclosure also refers to a foaming and heating system comprising a foaming and heating device as the one described and a machine to which the device is connected, the machine comprising single driving means entraining in rotation both the pumping unit and the foaming unit; the machine further comprising an electrical connection to heat the heating unit.

In certain non-limiting embodiments, the foaming and heating system of the present disclosure further comprises an air connection providing air through the air inlet in the device to foam the fluid.

Typically, the machine and the device are horizontally arranged when being in use in the system of the present disclosure.

In certain non-limiting embodiments, the machine further comprises an electrical heating element configured as a resistance.

According to a first aspect, the present disclosure is directed to a foaming and heating device 10 for preparing hot fluid foams on demand.

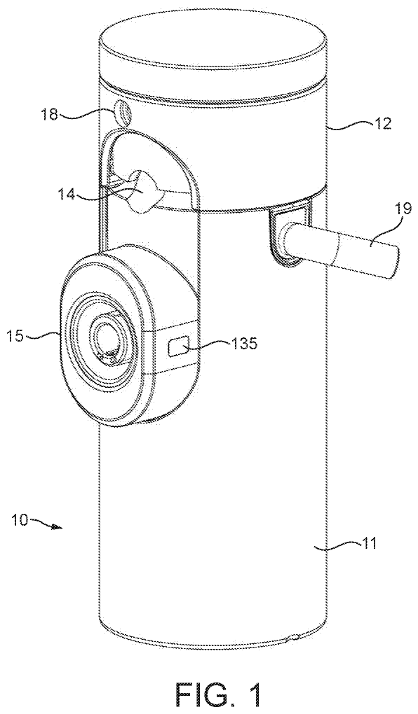

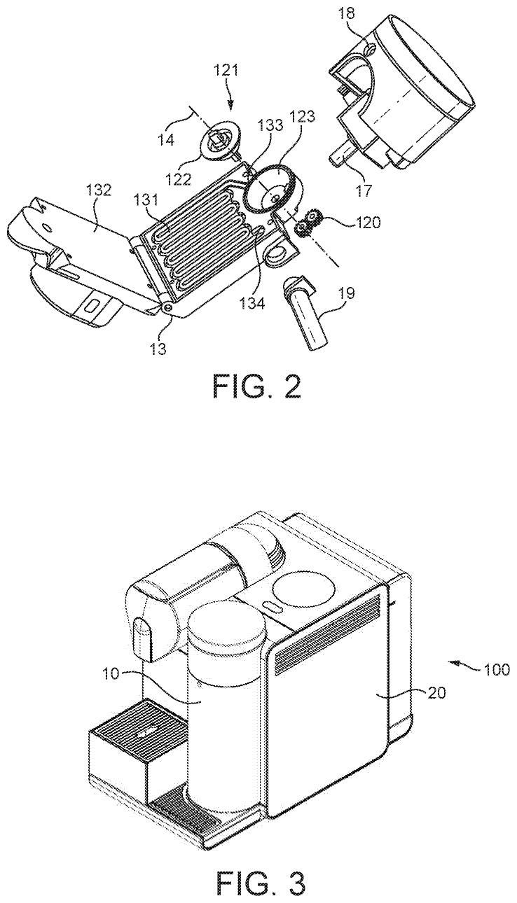

A first embodiment of the device is for example represented in FIGS. 1 and 2. The device 10 comprises a fluid container 11 where a foamable fluid is stored, a pumping and foaming unit 12 where the fluid is first pumped and later foamed together with air and a heating unit 13 where the foamed fluid is heated before being delivered. The pumping and foaming unit 12 together with the heating unit 13 are arranged together in order to form a compact and accessible unit, further allowing easy cleaning, as it will be further explained. Besides, the device 10 comprises a mechanical connection 14 through which movement is provided to the pumping and foaming unit 12, and an electrical connection 15 providing electrical current to the heating unit 13 in the device 10.

The foamable fluid or foamable food product is typically stored in the fridge, so it is kept refrigerated until fluid foam is going to be prepared; the foamable fluid or foamable food product can also be stored at ambient temperature, depending on the nature of the food or fluid. When arranged inside the fridge, it is the container 11 and typically the whole device 10 (together with the container 11) which are maintained refrigerated until they are taken out from the fridge and are plugged to the machine to start foam preparation.

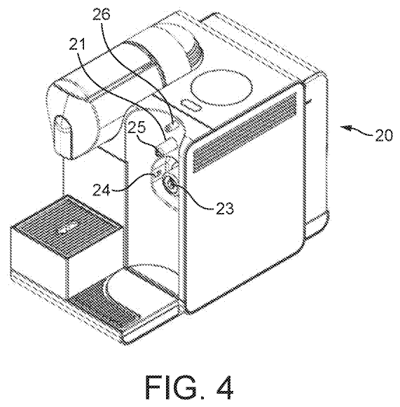

As shown in more detail in FIG. 2, the pumping and foaming unit 12 comprises a pumping unit 120 and a foaming unit 121, both entrained in rotation together by means of a single rotation provided through the mechanical connection 14: typically by means of the same rotation provided to a rotational shaft 21 in the machine (see FIG. 4, for example), the pumping unit 120 rotates and so pumps fluid and optionally also air from a fluid inlet 17 (here only a part of it has been represented, though it should be understood to be much longer, down to the inner volume of the container 11 so as to be able to pump or suck fluid into the foaming unit 12) and then that same rotation is used in the foaming unit 121 to foam the fluid and air mixture coming from the pumping unit 120 by using Couette Flow effect. The rotational shaft 21 is driven in rotation by means of a single motor arranged in a machine as it will be further detailed.

The pumping unit 120 is typically configured as gears (gear elements) that, when rotating at high speed, pump/suck fluid or food product through the fluid inlet 17 and also air through the air inlet 18 throughout their teeth so that pumping and mixing is achieved (it can also be considered that some sort of pre-foaming of the mixture is obtained when entraining air and fluid through the teeth). The mixture of fluid and air is then directed into the foaming unit 121, comprising a rotatable part with respect to another part, such as (but not limited to) static, such that a small gap is created between the two: the fluid or food product mixed with air and coming from the pumping unit 120 goes into this gap where it is subjected to high shear stress forces which make the mixture foam by Couette Flow effect.

Typically, as represented in FIG. 2, the foaming unit 121 comprises a rotatable element 122 rotating with respect to a static element 123 (even when named as such, it is also possible that both elements rotate, and typically at different rotational speeds with respect to each other). The two elements 122 and 123 form a gap (typically a thin gap) between them through which the mixture of fluid and air coming from the pumping unit 120 flows, and is subjected to high shear stress which makes it foam by Couette Flow effect.

The module (i.e. the size), the number and the height of the teeth configuring the gears in the pumping unit 120 need to be carefully chosen, together with the shape and size of the foaming unit 121, so as to have a good balance between the pumping performance of the pumping unit 120 and the foaming capability of the foaming unit 121 (i.e. so as to obtain the desired balance of pumping and foaming in the device 10 of the present disclosure). Typically, a too efficient pumping would result in bad quality foam.

After exiting the foaming unit 121, the foamed mixture enters a heating unit 13, as shown in FIG. 2. According to the present disclosure, either cold foam can be provided (thus, the heating unit 13 will not be activated) or hot foam is provided instead when the heating unit 13 is activated. Typically, the heating unit 13 comprises a heating path 131 with a serpentine or labyrinth shape allowing sufficient time and contact area for the mixture to be heated, and a heating plate 132 heating by contact the path where the mixture flows. Heating is provided by the electrically heated heating plate 132. Other executions of the heating unit 13 are also possible according to the present disclosure.

FIG. 1 also shows the electrical connection 15 for the heating unit 13, typically a connection of 230V for an electrical heating insert. The mechanical connection 14 is also represented in FIG. 1, where the rotational shaft 21 of the driving means in the machine will connect to enter in rotation the pumping and foaming unit 12 of the device. The product entry 133 to the heating unit 13 and the product outlet 134 from the heating unit 13 are also represented in FIG. 2. It can also be seen that the fluid or food product follows the heating path 131, contacting the heating plate 132, so that it is delivered hot through the outlet 134. The heating unit 13 further typically comprises a temperature sensor (not shown, located behind the heating plate 132 or in the heating unit 13, and connected to the machine through the connector 135) allowing measuring the temperature of the fluid or of the heating element or of the heating plate.

The machine 20 in the system 100 typically comprises driving means 22, such as (but not limited to) a motor, driving a rotational shaft 21 which entrains in rotation both the pumping unit 120 and the foaming unit 121. As already explained, the same single rotation of the driving means is able to entrain in rotation both means, so both functions of pumping and foaming can be achieved.

The device 10 represented in FIGS. 1 and 2 is used together with a machine as represented in FIG. 3 or 4: it is plugged or connected to it easily in a compact way. The machine 20 comprises an electrical connection 23 to connect to the connection 15 in the device 10, a sensor connection 24 to connect to the connector 135 in the device, a mechanical connection 25 for the corresponding connection 14 in the device 10 and an air connection 26 to connect to the air inlet 18 in the device 10. Therefore, when the foaming and heating device 10 is connected or plugged to the machine 20, the corresponding connections to heating, sensing, aeration and rotation are performed, so the device is ready to be used.

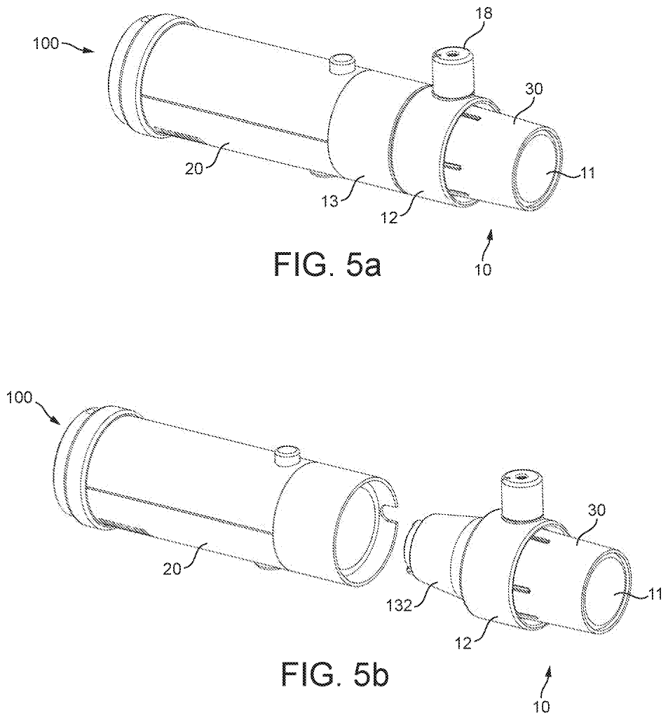

FIGS. 5a-b, 6a-b and 7a-b further represent a second embodiment of the foaming and heating device 10 of the present disclosure. As shown, the device also comprises a fluid or food product container 11 connected to a pumping and foaming unit 12 where the fluid or product from the container 11 is first pumped and later foamed.

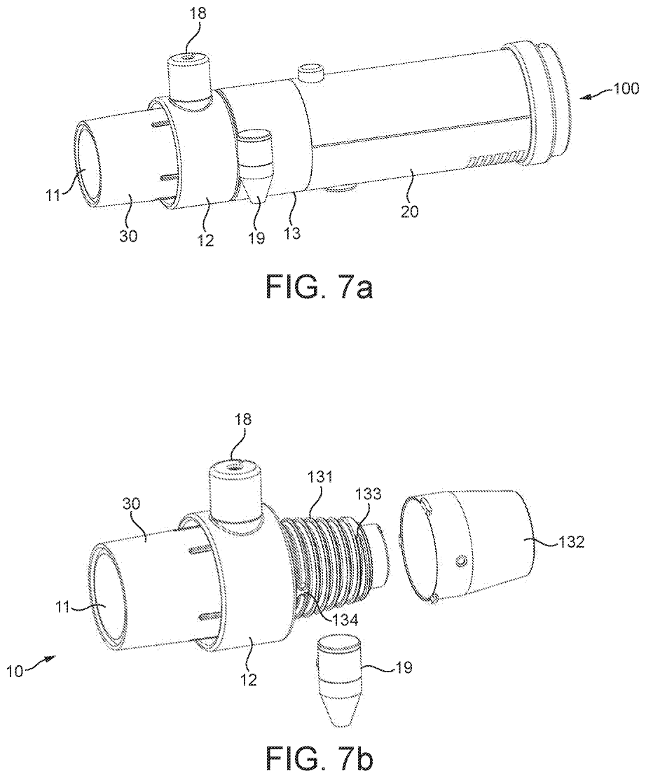

Typically, according to this second embodiment, the container 11 is configured as a capsule, comprising inside the fluid or food product, and is arranged in a capsule holder 30 configured and shaped to receive the mentioned capsule 11. The pumping and foaming unit 12 further comprises an adjustable air inlet 18, as shown in the Figures. Once the product has been prepared, it is delivered through a product outlet 19, typically with the shape of a nozzle or the like (see FIGS. 7a-b).

In the embodiment represented in FIGS. 5a-b, the device 10 is connected to the machine 20 in a compact way, and the arrangement of both is, in certain non-limiting embodiments, made horizontally. FIG. 5b shows how the device 10 can be separated from the machine 20, and it is also shown the heating plate 132. The pumping and foaming unit 12 and the heating path 131+132 are made entirely removable from the machine 20 so that they can be easily cleaned while the heating element remains inside the machine.

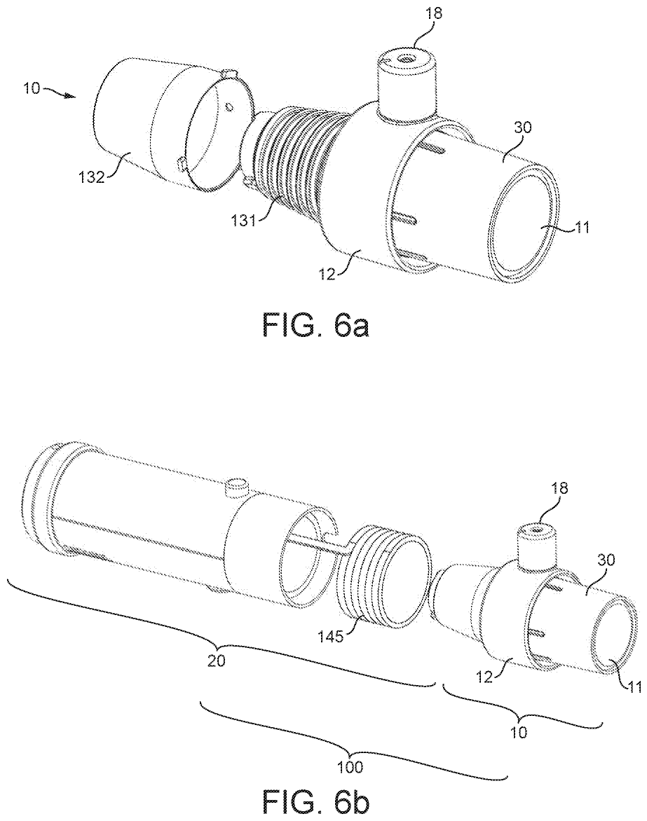

A further detail of the configuration of the heating unit 13 is represented in FIG. 6a, where it is shown the fluid path 131 through which the fluid or food product flows, being heated in that path by the heating plate 132, which is configured as a heating sleeve. FIG. 6b shows that, opposite to the heating plate 132 there is a heating element 145 arranged in the machine 20 (typically configured as an electrical resistance) in order to come into contact with the sleeve 132 and therefore heat the product flowing through the path 131.

The product entry 133 to the heating unit and the product outlet 134 from the heating unit are shown in FIG. 7b. The product outlet 134 communicates directly to the outlet 19, typically shaped as a nozzle, from which the prepared product is delivered.

Further, FIG. 7a shows another side view of the device 10 and the machine 20 according to this embodiment, showing a possible arrangement of the product outlet 19, typically configured as a nozzle. A further detail of the configuration of the device 10 of the present disclosure can be seen in FIG. 7b, showing in the path 131 the arrangement of the product entry 133 to the heating unit 13 and of the product outlet 134 from the heating unit 13, as well as the heating sleeve 132, the fluid container 11 configured as a capsule and the capsule holder 30 receiving the capsule.

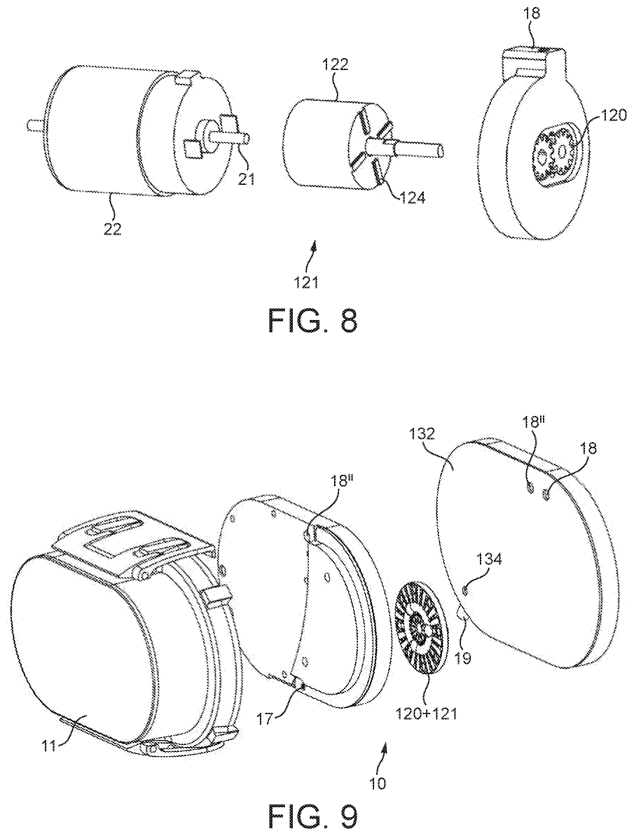

FIG. 8 represents in detail some of the components of the system according to the second embodiment: the driving means 22, typically configured as a single motor, the foaming unit 121 (the chamber and the gap in which Couette Flow effect takes place is not represented here, only a part of it is represented as a cylinder) and the pumping unit 120, comprising the gears which rotation pumps or sucks the fluid into the gap in the pumping unit 120. In FIG. 8, the rotatable element 122 is represented as a foaming cylinder comprising propelling elements 124 to evacuate bigger pieces of food which may be blocked or stacked in the foaming chamber.

Typically (but not by way of limitation), the fluid or food product processed in the device 10 of the present disclosure is a food or beverage liquid, particularly a foamable liquid such as milk, though any kind of foamable fluid can be used, such as cream, yoghurt, ice-cream liquid mix, non-dairy products or mixes, etc. Also, other foamable food products, such as vegetable foams, sauces, liquid purées, etc. can be foamed with the device of the present disclosure, which can also comprise food pieces.

In certain non-limiting embodiments, the pumping unit 120 and the foaming unit 121 rotate (entrained by the same driving means 22 and connected through the shaft 21) at high speed, typically comprised between 2000 and 10000 rpm, such as (but not limited to) between 4000 and 8000 rpm.

As represented in FIG. 2 and in FIGS. 6a-b, 7b, the heating unit 13 can be easily removed and disassembled so that it can be cleaned in a proper way.

It is also possible, using a system as the one in the present disclosure, to provide hot fluid not foamed, for example, by simply closing the air inlet 18, so that no air bubbles are entrained together with the fluid and thus no foam is obtained.

Cleaning of different parts of the device 10 of the present disclosure can be made by separating them so that cleaning is made in an easy way. Typically, the fluid container 11 can be removed from the device 10 and can be cleaned once it has been used (when using a capsule configuration, as shown in FIGS. 6a-b for example, the capsule is removed and disposed once its content has been completely used). The heating unit 13 can be disassembled as represented in FIG. 2 or in the embodiment of FIGS. 6a and 6b, so it can be made accessible and be cleaned in the parts where the fluid or food product has circulated. In a similar way, the pumping unit 120 and the foaming unit 121 can also be separated from the pumping and foaming unit 12 and can therefore be cleaned. Also, the fluid inlet 17 can be removed and cleaned (see FIG. 2) and so can be the product outlet 19 (see FIG. 2 or FIGS. 7a-b).

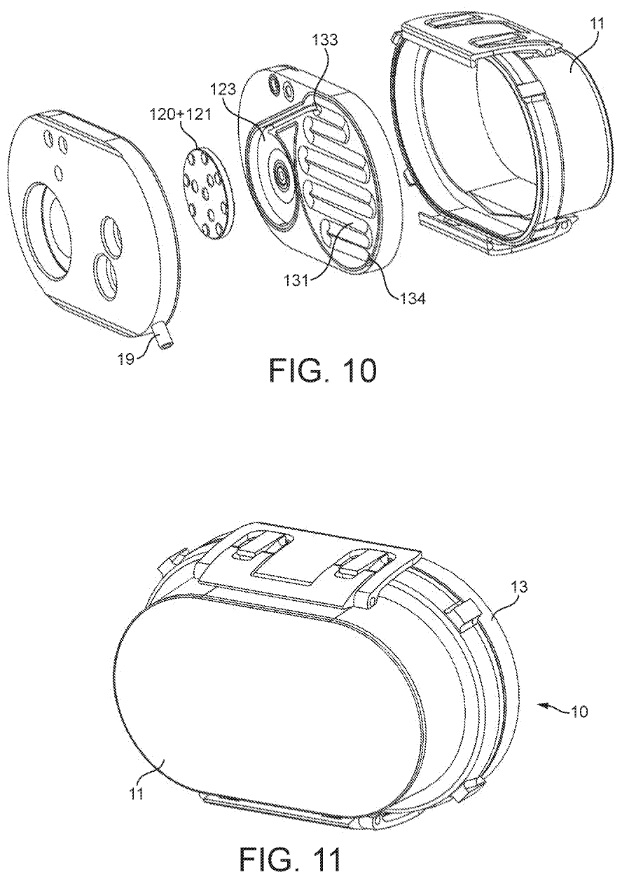

FIG. 9 represents a third embodiment of the device 10 of the present disclosure: the fluid container 11 (typically for milk) can be connected to the pumping and foaming unit 12 and the heating unit 13 for example (but not by way of limitation) by means of a quick connection as the one shown in FIG. 9. In this third embodiment, the pumping unit 120 and the foaming unit 121 are both configured as a single element, having the shape of a disc. The rotation of the disc firstly allows the pumping or sucking of both air and fluid: fluid through the fluid inlet 17, together with air being provided into the mixture through the adjustable air inlet 18, as shown in FIG. 9 or 10. At the same time as pumping, the mixture is attained and also its foaming is achieved as the mixture is subjected to high shear stress through the thin gap formed by the disc and the static element 123: therefore, as in the two previous embodiments, the mixtures is foamed by Couette Flow effect. That is to say, the disc of the device provides at the same time with its rotation three functions: pumping of fluid and air, mixing and foaming. Once foamed, the fluid mixture enters the fluid path 131 through the product entry 133 to the heating unit 13 and leaves it, once heated, through the product outlet 134 from the heating unit 13 and, from there, directly delivered outside through the product outlet 19.

FIG. 11 represents in further detail the fluid container 11 connected to the heating unit 13, the mixing and foaming unit 12 being arranged in the middle, between these two.

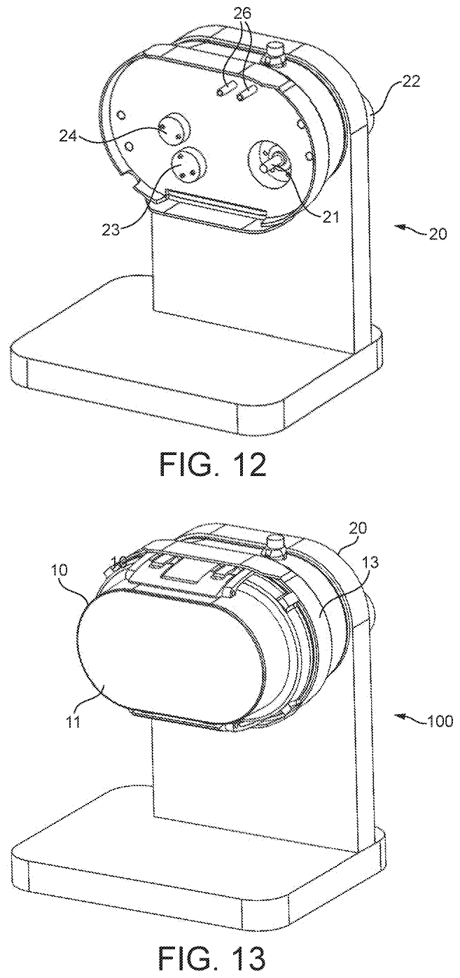

FIG. 12 shows the machine 20 to which a device 10 according to the third embodiment of the present disclosure is connected, as the one represented in FIG. 9 or 10. The machine 20 comprises an electrical connection 23 to connect to the connection 15 in the device 10 for the heating unit 13, typically a connection of 230V for an electrical heating insert as in previous embodiments; a sensor connection 24 to connect to the connector 135 in the device allowing measuring the temperature of the fluid or of the heating element or of the heating plate; a rotational shaft 21 driven in rotation by means of a motor 22 and driving in rotation itself the disc allowing the pumping, mixing and foaming of the fluid and air; and an air connection 26 to connect to the adjustable air inlet 18 in the device 10 and also to the secondary air entry 18″. Therefore, when the foaming and heating device 10 is connected or plugged to the machine 20, the corresponding connections to heating, sensing, aeration and rotation are performed, so the device is ready to be used. FIG. 13 shows the device 10 according to this third embodiment plugged to a machine 20 as the one described in FIG. 12.

Looking at FIG. 9, the heating element 132 (heating the fluid path 131) comprises a primary air entry 18 directly connected to the pumping and foaming unit 12 in the device 10, providing air to the fluid mixture. Also, this element 132 can be provided with a secondary air entry 18″, which is optional, and which allows air entry into the container 11 to replace the fluid being extracted and being processed and further delivered. In fact, this secondary air entry 18″ will be used when the fluid container 11 is sealed and is connected to the machine 20 so that air can replace the fluid having been sucked out so that further fluid can be pumped from the container 11.

Some of the advantages of the system of the present disclosure, are now summarized in what follows:
the system is able to provide hot fluid or hot fluid foam on demand;
there are no parts of the machine that are in contact with the fluid or the fluid foam (the system is configured in direct flow or in-line), which minimizes cleaning operations required;
the parts of the device that are in contact with the fluid or fluid foam are made easily disassembled so they can be easily cleaned or easily accessible to be cleaned;
the fluid foam is heated very gently (thus being provided with a very high quality) as there is no direct contact between the foam and the heating source;
contamination is avoided as the device can be easily cleaned after each operation or dosing;
the heating path is configured in such a way that it can be easily cleaned, as it typically comprises a full flat surface easily accessed and cleaned;
the low inertia of the heating element (compared for example to that of a traditional thermoblock) allows to quickly switch from hot to cold preparation or vice versa without having two additional paths (this would be the case of the thermoblock configuration) that would require additional valves and control, among other things.

Although the present disclosure has been described with reference to particular embodiments thereof, many modifications and alterations may be made by a person having ordinary skill in the art without departing from the scope of this present disclosure which is defined by the appended claims.

1. A foaming and heating device for foaming and/or heating a fluid or a fluid foam on demand, comprising:
a fluid container where a foamable fluid is stored;
a pumping unit and a foaming unit, both entrained in rotation by a single shaft, such that this same rotation provides pumping of the fluid from the container and foaming of it when air is introduced through an air inlet;
a heating unit characterized in that the heating unit comprises a path through which the foamed fluid flows and a heating element arranged facing this path so that the fluid can be heated; and
wherein the heating element is electrically heated.

2. The foaming and heating device according to claim 1, wherein the path is configured having a labyrinth shape, the heating element being configured as an electrically heated surface covering the planar surface of the path.

3. The foaming and heating device according to claim 1, wherein the path is configured as a conical spiral, the heating element being configured as an outer conical sleeve matching the spiral, electrically heated.

4. The foaming and heating device according to claim 1, wherein the pumping unit is configured as gears.

5. The foaming and heating device according to claim 1, wherein the foaming unit is configured as a disc, as a cone, or as a cylinder.

6. The foaming and heating device according to any of claim 1, wherein the foaming unit comprises a rotatable element with respect to a static element defining a gap where a mixture of fluid and air is driven under shear stress to be foamed.

7. The foaming and heating device according to claim 6, wherein the pumping unit is the same as the foaming unit, both being configured as a single rotatable disc.

8. The foaming and heating device according to claim 6, wherein the gap is comprised between 0.2 and 1 mm.

9. The foaming and heating device according to claim 4, wherein the module and/or number and/or height of the teeth configuring the gears in the pumping unit, and the shape and/or size of the foaming unit are calculated so as to have a specific balance between the pumping performance and the foaming capability, respectively, provided by the device.

10. The foaming and heating device according to claim 1, further comprising a temperature sensor to measure the heating unit temperature.

11. The foaming and heating device according to claim 1, wherein the pumping unit and the foaming unit rotating around the shaft at a speed comprised between 2000 and 10000 rpm.

12. The foaming and heating device according to claim 1, wherein the pumping unit, the foaming unit, and the heating unit are made detachable and accessible for being cleaned.

13. The foaming and heating device according to claim 1, further comprising a secondary air entry for injecting air into the container in order to replace the fluid removed from it.

14. A foaming and heating system comprising:
a device according to claim 1; and
a machine to which the device is connected, the machine comprising:
single driving means entraining in rotation both the pumping unit and the foaming unit; and
an electrical connection to heat the heating unit.

15. The foaming and heating system according to claim 14, further comprising an air connection providing air through the air inlet in the device to foam the fluid.

16. The foaming and heating system according to claim 14, wherein the machine and the device are horizontally arranged when being in use.

17. The foaming and heating system according to claim 14, wherein the machine further comprises an electrical heating element configured as a resistance.

18. The foaming and heating device according to claim 6, wherein the gap is comprised between 0.3 and 0.6 mm.

19. The foaming and heating device according to claim 6, wherein the module and/or number and/or height of the teeth configuring the gears in the pumping unit, and the shape and/or size of the foaming unit are calculated so as to have a specific balance between the pumping performance and the foaming capability, respectively, provided by the device.

20. The foaming and heating device according to claim 1, wherein the pumping unit and the foaming unit rotating around the shaft at a speed comprised between 4000 and 8000 rpm.
